(19) United States
(12) Patent Application Publication
(10) Pub. No.: US 2009/0268296 A1
(43) Pub. Date: Oct. 29, 2009

(54) TRANSPARENT DISPLAY COVER AND METHOD OF MAKING

(75) Inventors: Steven R. Young, Gilbert, AZ (US); Larry E. Marvet, Buffalo Grove, IL (US); Steven A. Voight, Gilbert, AZ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/111,669

(22) Filed: Apr. 29, 2008

(51) Int. Cl. G02B 1/11; B05D 3/00; B05D 1/36

(52) U.S. Cl. 359/581; 427/296; 427/419.1

(57) ABSTRACT

A transparent display cover (100) and a method of forming such includes forming (204) a transparent polymer material (104) having a thickness between 0.2 and 38 micrometers on a glass material (102) and disposing (216) one of the materials (106) selected from the group consisting of an antireflective coating and a vacuum metallized coating on the transparent polymer material (104). The transparent polymer material (104) may comprise one of a polyimide, siloxane, polyurethane, polyester, polycarbonate, and polyethylene applied (204) by spin coat or meniscus with a thickness of less than 38 micrometers.

### FIELD

The present invention generally relates to coatings for lenses or display covers, and more particularly to a method for a coating a thin, supportive layer on a glass lens.

### BACKGROUND

In many portable electronic devices, such as mobile communication devices, displays present video and text information to a user. These optical displays, for example touch panel displays, typically comprise a transparent protective layer including a high gloss reflective surface of glass or a polymer. Glass typically offers a higher scratch resistance. While these transparent protective layers have excellent transparency and are relatively physically strong, they may suffer physical damage due to harsh treatment by the user. This is particularly true for the displays of products which receive significant handling, such as personal digital assistants (PDAs) and cell phones.

In order to reduce distracting reflections from the surface of the transparent protective layer, conventional displays place either an antireflective coating or a decorative vacuum metallized coating over the surface by laminating a dry stack of adhesive polymer film, and a hard film such as titanium dioxide or silicon oxide onto the glass. Placement of these hard films directly onto the glass layer is known to decrease the impact or fracture strength of the glass due to the mismatch of the mechanical and structural properties of the glass and these coatings.

Accordingly, it is desirable to provide a method for applying a relatively thin antireflective or vacuum metallized coating onto glass that improves the impact or fracture strength of the glass. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is a partial cross section of the lens in accordance with an exemplary embodiment;

FIG. 2 is a flow chart of the process for making the exemplary embodiment;

FIG. 3 is a front view of a mobile communication device having a touch screen in accordance with an exemplary embodiment; and

FIG. 4 is a partial cross-section of a conventional touch screen taken along line 4-4 of FIG. 3.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An optically clear polymer material disposed between a glass lens and an antireflective coating or a vacuum metallized optical coating improves the impact or fracture strength of the glass lens. The polymer material preferably is spin, spray, or meniscus coated so molecules of the polymer material attach to the glass lens, preferably at a thickness below 38 micrometers, and more preferably at a thickness below 25 micrometers. The application of the polymer material prior to deposition of the antireflective or vacuum metallized optical coating provides a soft coating and buffer-like quality, thereby allowing for the use of a thinner glass lens.

Referring to FIG. 1, a partial cross section of an exemplary embodiment of a lens 100 includes a glass layer 102, which may be referred to in the industry by any one of several names such as lens, substrate, and protective cover. The glass layer 102 is preferably rigid and may be formed of any suitable translucent material having suitable optical properties and by any suitable method. The glass layer 102 has a thickness preferably in the range of 0.5 to 0.85 millimeters, although it could be much thinner. It is preferred to clean the glass layer 102 using an industry standard cleaning process. One known process includes submerging the glass layer 102 into a 90° C. 4:1 Piranha (four part sulfuric acid to one part hydrogen peroxide) solution for five minutes followed by a SC-1 MegaSonic clean process (D.I. water, ammonium hydroxide, and hydrogen peroxide solution) for 30 minutes at 60° C. The glass layer 102 is then rinsed clean and dried prior to the next step in the process.

In accordance with the exemplary embodiment, a thin layer 104 of a polymer material is formed on the glass layer 102. The layer 104 is preferably spin, spray, or meniscus coated so molecules of the polymer material attach to the glass. The thin layer 104 is disposed on the “inside” of the layer 102. In other words, the side 103 of the layer 102 faces the viewer of the lens 100. These methods allow for the layer 104 to be thin when compared to previously known methods, by having a thickness preferably less than 38 micrometers, and more preferably less than 25 micrometers, for example when maintaining anti-splinter characteristics. The polymer layer 104 may be any polymer, but preferably is one of a polyimide, siloxane, polyurethane, polyester, polycarbonate, and polyethylene material. A polyurethane layer has shown good anti-splintering qualities.

A coating 106, for example a metal or an alloy such as indium tin oxide, titanium oxide, or a conductive polymer, of either an antireflective material to reduce reflection or a vacuum metallization for decoration is deposited on the polymer layer 104. The coating 106 may have a thickness in the range of 0.05 to 0.25 micrometers, but preferably has a thickness of about 0.15 micrometers. The polymer layer 104 provides a buffer-like quality that maintains the fracture strength of the glass layer 102 when the coating 106 is applied. The combination of layers 102, 104, 106 has a light transmission value of 65-98% between the wavelengths of 400 to 700 nanometers to maintain the desired optical quality and an index of refraction that closely matches glass to reduce any optical aberrations or image distortion.

The layers 102, 104, 106 have the right balance of tensile strength, Young's Modulus, modulus of elasticity, and coefficient of thermal expansion to maintain the integrity of the layers 102, 104, 106 through environmental conditions while reducing the negative effects of the layers 104, 106 on the fracture and impact strength of the glass layer 102. Tensile strength of a material is the maximum amount of tensile stress that it can be subjected to before failure. Stress is a measure of the average amount of force exerted per unit area. It is a measure of the intensity of the total internal forces acting within a body across imaginary internal surfaces, as a reaction to external applied forces and body forces, and is measured in units of pascals (Pa), or Newtons per square meter. Young's modulus, synonymously with modulus of elasticity, is the ratio of tensile stress to the resulting strain, which reflects the resistance of a material to elongation. The higher the Young's modulus, the larger the force needed to deform the material.

This process produces a favorable situation where a relatively soft (low Young's Modulus) layer is interposed between the harder glass and optical coating layers. This allows for easier relative movement of the hard layers thereby reducing the possibility that these layers might fracture.

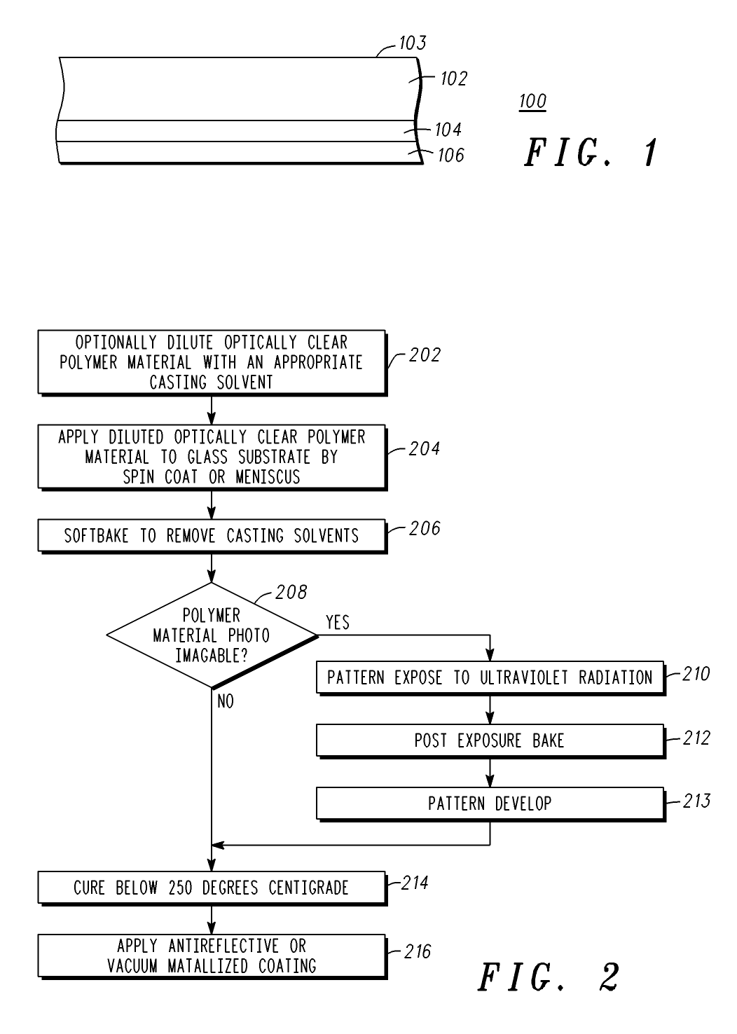

The method 200 of the exemplary embodiments is shown in FIG. 2 and includes the steps of optionally diluting 202 an optically clear polymer material 104 with an appropriate solvent, ethyl lactate for example, and applying 204 the polymer material 104 to a clean glass layer 102 by spin, spray, or meniscus coating. Other coating processes that may be used include roller coating, screen printing, and dip coating, for example. The layers 102, 104 are then baked 206 at a temperature in the range of 80° to 120° C., but preferably at 100° C., for about 120 seconds. If the polymer layer 104 is photo-imageable 208, it can be patterned, if deemed necessary, using industry standard photolithography methods, such as UV pattern expose 210, post exposure bake 212, and developing techniques 213. The layers 102, 104 are then cured 214, preferably below 250° C. in air or an industry standard nitrogen atmosphere process for two hours. Once cured, the layer 102 film properties consist of the right balance of tensile strength, Young's Modulus, modulus of elasticity, and coefficient of thermal expansion to maintain the integrity of the layers 102, 104, 106 through environmental conditions while reducing the negative effects of the layers 104, 106 on the fracture and impact strength of the glass layer 102. Material property values of layer 102 can range from 6.0 to 176 MPa for tensile strength, 90 MPa to 7.8 GPa for Young's modulus, and 25 to 125% for elongation. The antireflective or vacuum metallized coating is then deposited 216.

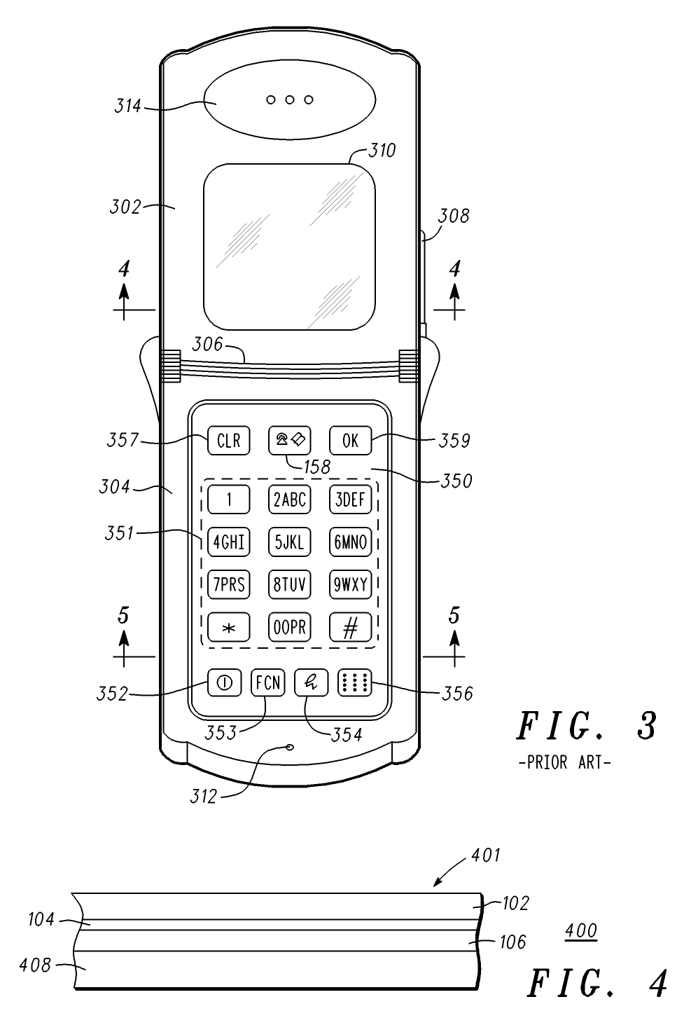

Although the apparatus and method described herein may be used with an exposed display surface for any type of device, the exemplary embodiment as shown in FIG. 3 comprises a mobile communication device 300 implementing a touchscreen. While the electronic device shown is a mobile communication device 300, such as a flip-style cellular telephone, the touchscreen can also be implemented in cellular telephones with other housing styles, personal digital assistants, television remote controls, video cassette players, household appliances, automobile dashboards, billboards, point-of-sale displays, landline telephones, and other electronic devices. Non-electric apparatus in which the exemplary embodiment could be used include lens for eyewear, glass windows, clocks and the like.

The mobile communication device 300 has a first housing 302 and a second housing 304 movably connected by a hinge 306. The first housing 302 and the second housing 304 pivot between an open position and a closed position. An antenna 308 transmits and receives radio frequency (RF) signals for communicating with a complementary communication device such as a cellular base station. A display 310 positioned on the first housing 302 can be used for functions such as displaying names, telephone numbers, transmitted and received information, user interface commands, scrolled menus, and other information. A microphone 312 receives sound for transmission, and an audio speaker 314 transmits audio signals to a user.

A keyless input device 350 is carried by the second housing 304. The keyless input device 350 is implemented as a touchscreen with a display. A main image 351 represents a standard, twelve-key telephone keypad. Along the bottom of the keyless input device 350, images 352, 353, 354, 356 represent an on/off button, a function button, a handwriting recognition mode button, and a telephone mode button. Along the top of the keyless input device 350, images 357, 358, 359 represent a “clear” button, a phonebook mode button, and an “OK” button. Additional or different images, buttons or icons representing modes, and command buttons can be implemented using the keyless input device. Each image 351, 352, 353, 354, 356, 357, 358, 359 is a direct driven pixel, and this keyless input device uses a display with aligned optical shutter and backlight cells to selectively reveal one or more images and provide contrast for the revealed images in both low-light and bright-light conditions.

Referring to FIG. 4, a cross section of a lens 400 is depicted that is usable for either the display 310 or the keyless input device 350 with the cross-section, for example, being a portion of a view taken along line 4-4 or 5-5 of FIG. 3. The lens 400 is a stack with a user-viewable and user-accessible face 401 and multiple layers below the face 401, including layers 102, 104, 106, and an imaging device 408. The layer 102 provides an upper layer viewable to and touchable by a user and may provide some glare reduction. The layer 102 also provides scratch and abrasion protection to the layers 104, 106, 408 contained below.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method comprising:
forming a transparent polymer material having a thickness less than 38.0 micrometers on a glass material; and
disposing one of the materials selected from the group consisting of an antireflective coating and a vacuum metallized coating on the transparent polymer material.

2. The method of claim 1 wherein the forming step comprises forming a transparent polymer material selected from one of the group consisting of a polyimide, siloxane, polyurethane, polyester, polycarbonate, and polyethylene.

3. The method of claim 1 wherein the forming step is selected from one of the group consisting of spin coating, meniscus coating, spray coating, roller coating, screen printing, and dip coating.

4. The method of claim 1 wherein the forming step comprises forming the transparent polymer material having a thickness less than 25 micrometers.

5. The method of claim 1 wherein the forming step comprises forming a transparent polyurethane material.

6. The method of claim 1 wherein the disposing step comprises disposing the one of the materials to a thickness of between 0.05 to 25.0 micrometers.

7. The method of claim 1 wherein the forming step and the disposing step comprises forming layers of the glass material, the transparent polymer material, and the one of the materials having a light transmission value of 65 to 98% between the wavelengths of 400 to 700 nanometers.

8. A method of forming a lens comprising:
forming an optically transparent layer on a glass layer; and
disposing one of the materials selected from the group consisting of an antireflective coating and a vacuum metallized coating on the transparent polymer material.

9. The method of claim 8 wherein the forming step comprises forming a transparent polymer material selected from one of the group consisting of a polyimide, siloxane, polyurethane, polyester, polycarbonate, and polyethylene.

10. The method of claim 8 wherein the forming step is selected from one of the group consisting of spin coating, meniscus coating, and spray coating.

11. The method of claim 8 wherein the forming step comprises forming the transparent polymer material having a thickness less than 38 micrometers.

12. The method of claim 8 wherein the forming step comprises forming the transparent polymer material having a thickness less than 25 micrometers.

13. The method of claim 8 wherein the forming step comprises forming a transparent polyurethane material.

14. The method of claim 8 wherein the forming step is selected from one of the group consisting of electrophoretic deposition, roller coating, screen printing, and dip coating.

15. A lens comprising:
a glass layer;
a transparent polymer coating having a thickness between 0.2 and 38 micrometers disposed on the glass layer; and
one of the materials selected from the group selected from an antireflective coating or a vacuum metallized coating disposed on the transparent polymer material.

16. The lens of claim 15 wherein the transparent polymer material comprises a material selected from one of the group consisting of a polyimide, siloxane, polyurethane, polyester, polycarbonate, and polyethylene.

17. The lens of claim 15 wherein the transparent polymer material comprises a thickness less than 38 micrometers.

18. The lens of claim 15 wherein the transparent polymer material comprises a thickness less than 25 micrometers.

19. The lens of claim 15 wherein the transparent polymer material comprises a transparent polyurethane material.
